(19) United States
(12) Patent Application Publication
(10) Pub. No.: US 2020/0108948 A1
(43) Pub. Date: Apr. 9, 2020

(54) CONTAINMENT APPARATUS FOR AN UNMANNED AERIAL VEHICLE AND METHOD FOR INSTALLING THE SAME

(71) Applicant: Mid-American Gunite, Inc. dba Mid-American Group, Newport, MI (US)

(72) Inventor: Keith P. Masserant, Newport, MI (US)

(73) Assignee: Mid-American Gunite, Inc. dba Mid-American Group, Newport, MI (US)

(21) Appl. No.: 16/152,681

(22) Filed: Oct. 5, 2018

(51) Int. Cl. B64F 1/02; B66D 1/60

(52) U.S. Cl. CPC B64F 1/02; B64C 39/024; B66D 1/60

(57) ABSTRACT

A containment apparatus and a method for installing the same is provided. The containment apparatus includes a plurality of panels, each of which extends along a height and comprises a panel perimeter including a plurality of perimeter portions, and a panel interior disposed within the panel perimeter. The plurality of perimeter portions includes an attachment border, a coil border, and a set of opposing side portions, which define a respective panel width therebetween. When the containment apparatus is in the installed position, the attachment border of a respective panel is operatively attached to the roof of a structure, such that the plurality of panels and at least one of the exterior walls of the structure cooperate to define a periphery of an unmanned aerial vehicle (UAV) containment area. The UAV containment area defines a controlled environment, directly adjacent to the structure, within which UAV may operate to inspect the structure.

### INTRODUCTION

The present disclosure relates to a containment apparatus for an unmanned aerial vehicle (UAV) and a method for installing the same. More specifically, a containment apparatus installed on a pre-existing structure, which creates a controlled environment for the operation of a UAV completing an inspection of the pre-existing structure.

### BACKGROUND

Inspecting structures such as commercial buildings, office buildings, multi-unit dwellings, single family homes, etc. for damage caused by weather or other sources can include significant time investments by inspection personnel trained to perform such inspections. Inspections of structures in highly populated or commercial areas can be particularly difficult due to the height of the relevant structures to be inspected.

As such, typical inspection procedures require significant build out of scaffolding or the like to allow the inspector to visually reach all areas of the structure for inspection. Further, such inspections also inherently require the inspector to physically climb on to the ledges and roof of the structure. Accordingly, such inspections are often lengthy and labor intensive, while also requiring extensive safety training for the inspection team.

Utilizing an unmanned aerial vehicle (UAV), the inspection of structures such as commercial buildings, office buildings, multi-unit dwellings, single family homes, may reduce overall inspection time and enable the structure to be maintained in a safer condition. Utilizing a UAV can allow the operator to quickly and safely obtain detailed images and/or other sensory data regarding the subject structure. Further, large areas of a structure may be inspected via UAV in a shortened time period, and hard-to-reach inspection areas may be inspected via UAV without requiring equipment such as cranes or raised and suspended platforms, which require inspection personnel to physically climb the raised or suspended platform to visually reach the pertinent inspection areas. Use of a UAV thereby reduces the safety risk to inspection personnel.

While utilizing an unmanned aerial vehicle (UAV) for the inspection of structures such as commercial buildings, office buildings, multi-unit dwellings, single family homes, etc. for damage caused by weather or other sources, may reduce overall inspection time, allow hard-to-reach areas to be easily inspected, and enable the structure to be maintained in a safer condition, it is important to control the UAV during inspection to minimize the risk of damage to the UAV itself, and minimize the occurrence of contact between the UAV and surrounding people and property.

### SUMMARY

A containment apparatus for an unmanned aerial vehicle (UAV) and a method for installing the same is provided. The containment apparatus is configured to contain the UAV within a controlled environment or a predefined inspection space, during the inspection of a pre-existing structure.

The containment apparatus includes a plurality of panels configured for attachment to the roof or one of the exterior side walls of the pre-existing structure. Each of the respective panels comprises a panel perimeter including a plurality of perimeter portions, and a panel interior disposed within the panel perimeter between the panel perimeter portions. The plurality of perimeter portions includes an attachment border, a coil border, and a set of opposing side portions. The opposing side portions further define a respective panel width therebetween, and the attachment border and the coil border define a panel height, when the panel is in an installed position.

When the containment apparatus is in an installed position, the attachment border of a respective panel is operatively attached to the roof of the structure, via a parapet attachment having an extension member which extends outwardly a predefined distance from the roof, such that the respective panel is disposed laterally from the respective exterior wall of the structure an attachment distance. Said another way, when the panel is in the installed position, the respective panel forms a removable barrier to at least one of the exterior walls of the pre-existing structure.

Accordingly, when the containment apparatus is in the installed position, the plurality of panels and at least one of the exterior walls of the pre-existing structure cooperate to define a periphery of a UAV containment area, which defines a controlled environment, directly adjacent to the structure, within which an unmanned aerial vehicle (UAV) may complete an inspection of the pre-existing structure.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is an isometric perspective view of an example pre-existing structure fitted with an example UAV containment apparatus.

FIG. 2 is an enlarged view of a portion of the UAV containment apparatus of FIG. 1 showing the detail of an example panel of the UAV containment apparatus.

FIG. 3 is an enlarged view of a portion of FIG. 1 showing the detail of the attachment of an example panel of the UAV containment apparatus to an extension member of a parapet attachment disposed upon a parapet of the roof of the pre-existing structure.

FIG. 4 is an isometric perspective view of an example pre-existing structure partially fitted with an example UAV containment apparatus, wherein the UAV containment apparatus is partially installed via the method of the present disclosure.

FIG. 5 is a flow diagram of the method of installation for an unmanned aerial vehicle (UAV) containment apparatus on a pre-existing structure having a roof and a plurality of exterior side walls of the present disclosure.

FIG. 6 is a flow diagram further detailing the step of transferring the panel from a coiled position to an installed position.

FIG. 7 is a flow diagram further detailing the step of transferring the panel from the installed position to the coiled position.

### DETAILED DESCRIPTION

While the present disclosure may be described with respect to specific applications or industries, those skilled in the art will recognize the broader applicability of the disclosure. Those having ordinary skill in the art will recognize that terms such as “above,” “below,” “upward,” “downward,” etc., are used descriptively of the figures, and do not represent limitations on the scope of the disclosure, as defined by the appended claims. Any numerical designations, such as “first” or “second” are illustrative only and are not intended to limit the scope of the disclosure in any way.

The terms “comprising,” “including,” and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

The terms “A,” “an,” “the,” “at least one,” and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The following discussion and accompanying figures discuss unmanned aerial vehicles (UAVs) 12, which may include any unmanned aerial vehicle, such as a drone, unpiloted aerial vehicles, remotely piloted aircraft, unmanned aircraft systems, etc. Although the UAV 12 is depicted as a drone in the associated Figures, these concepts may be applied to various types of UAVs 12.

Referring to the drawings, wherein like reference numerals refer to like components throughout the several views, a containment apparatus 10 for an unmanned aerial vehicle (UAV) 12 and a method 100 for installing the containment apparatus 10 on a pre-existing structure 16 is provided.

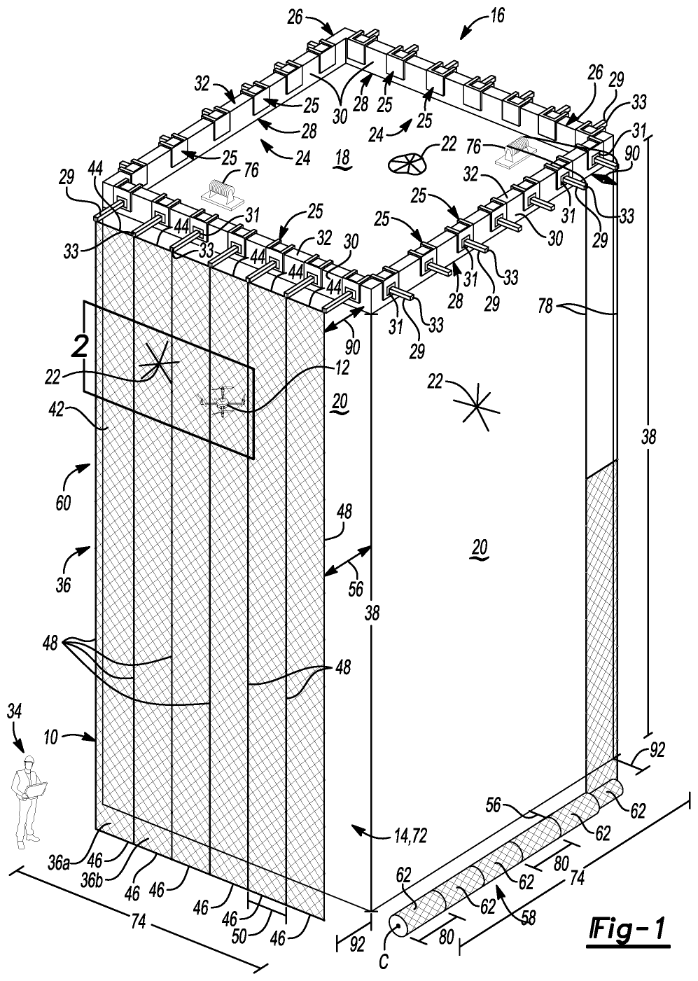

The containment apparatus 10 is configured to contain the UAV 12 performing an inspection of the pre-existing structure 16 for damage such as structural damage, weather damage, etc. Referring to FIG. 1, the containment apparatus 10 of the present disclosure is configured for attachment to a pre-existing structure 16 having a roof 18 and a plurality of exterior walls 20. The pre-existing structure 16 can be a commercial building, office building, multi-unit dwelling, single family home, or another structure. The roof 18 can have a boundary 24 formed by a top edge 28 of the plurality of exterior walls 20. Further, the roof boundary 24 forms a perimeter of the roof 18. The roof 18 can further include a parapet 26 having two vertical sides 30 and a top side 32. The parapet 26 may extend upward from the roof 18 to the top side 32 along an entirety of the boundary 24.

Referring to FIG. 3, the parapet 26 may be configured to receive a parapet attachment 25. The parapet attachment 25 can have a support structure 27, which is disposed over the top side 32 of the parapet 26 and configured to clamp to the two vertical sides 30 of the parapet 26. The parapet attachment 25 can further include an extension member 29 having a first end 31 proximate the support structure 27 and a second end 33 spaced apart from the support structure 27. The extension member 29 extends outwardly from the roof boundary 24 an attachment distance 90, such that the second end 33 is spaced apart the attachment distance 90 from the first end 31.

Referring to FIG. 1, the pre-existing structure 16 may contain a damaged area 22 upon the roof 18 and/or one of the respective exterior walls 20, which requires further inspection and/or assessment, but is difficult to reach or see clearly. Accordingly, utilizing an unmanned aerial vehicle (UAV) 12, an operator 34 can initiate an automatic scanning process of the pre-existing structure 16 and the damaged areas 22 thereof and quickly and safely obtain detailed image, video, or other sensory data regarding the damaged area 22. Further, large areas of a structure 16 can be inspected via UAV 12 in a shortened time period, and hard-to-reach inspection areas can be inspected via UAV 12 without requiring equipment such as cranes or raised and suspended platforms, which require inspection personnel to physically climb the raised or suspended platform structure to visually reach the pertinent inspection areas. Use of a UAV 12 thereby reduces the safety risk to inspection personnel.

However, specific regulations governing the use of UAVs 12 place limitations on how and under what conditions such UAV 12 inspections of pre-existing structures 16 may be performed. Accordingly, to comply with such regulations and requirements, the containment apparatus 10 of the present disclosure is configured to contain the UAV 12 within the UAV containment area 72, which defines a controlled environment 14, directly adjacent to the structure 16, within which an unmanned aerial vehicle (UAV) 12 can operate in a controlled manner, for example, to complete an inspection of the pre-existing structure 16 and identify damaged areas 22 thereof.

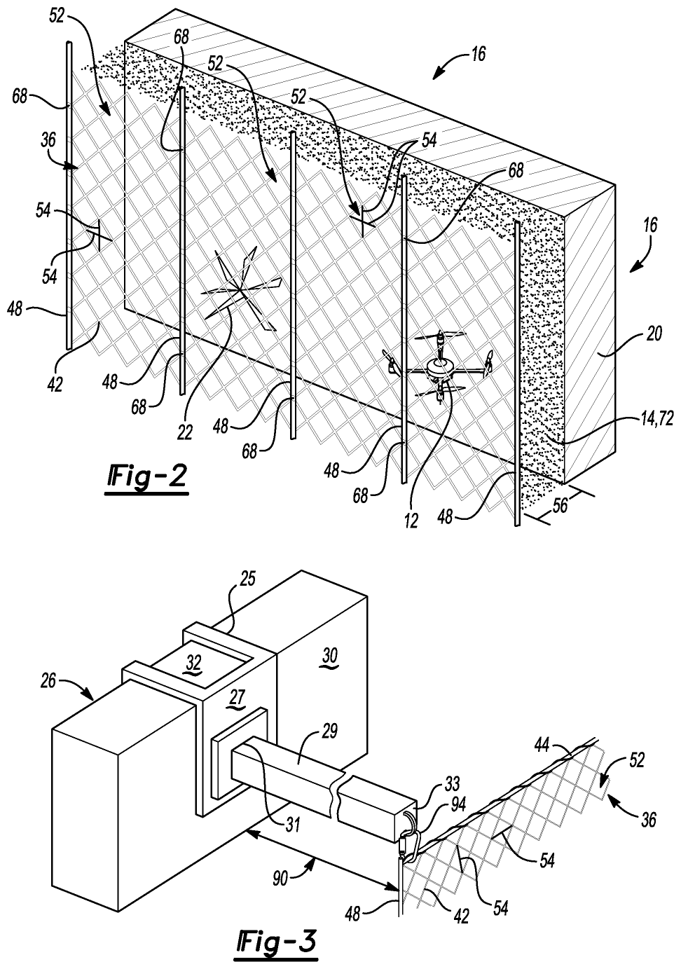

Referring to FIGS. 1 and 2, the containment apparatus 10 includes one or more panels 36. In the example shown, a plurality of panels 36 can include at least a first panel 36a and a second panel 36b. Each of the panels 36 includes a panel perimeter and a panel interior 42. The panel perimeter can have a plurality of perimeter portions 44, 46, 48. The panel perimeter portions 44, 46, 48 of each panel 36 include an attachment border 44, a coil border 46, and a set of opposing side portions 48. The set of opposing side portions 48 define a panel width 50 therebetween. When the panel 36 occupies an installed position 60, the coil border 46 is disposed opposite the attachment border 44, such that the panel 36 extends along a height 38 defined between the attachment border 44 and the coil border 46.

By way of example, the attachment border 44 and the opposing side portions 48 can be comprised of a rope or cable. For example, the rope or cable comprising the attachment border 44 and the opposing side portions 48 can be formed of a polymeric material, a metallic material, or a combination of these, such as a polymer coated wire cable or wire reinforced rope. In one example, the rope can be a twisted polypropylene rope having a diameter of about ⅜ inch and a tensile strength of about 2440 test/lb. The example is non-limiting.

By way of example, the coil border 46 can be formed as a rigid member. The coil border 46 can be a tubular rigid member, a solid cylindrical member, or a solid polygonal prism. The coil border 46 can be formed of a polymeric or a metallic material or a combination thereof.

The panel interior 42 is disposed within the panel perimeter 40 between the panel perimeter portions 44, 46, 48. In one example embodiment, the panel interior 42 comprises a mesh material. The mesh material can be a netting having a plurality of netting sections 52. The netting sections 52 can have a diameter 54 from about four inches to about fourteen inches. In one example, the netting sections 52 may have a diameter 54 of from about four inches to about eight inches. In another example, the netting sections 52 may have a diameter 54 of from about six inches to about ten inches. In another example, the netting sections 52 may have a diameter 54 of from about eight inches to about twelve inches. In another example, the netting sections 52 may have a diameter 54 of from about ten inches to about fourteen inches.

The diameter 54 of the netting sections 52 may be selected based upon the type, size, and/or configuration of the UAV 12. In order to ensure the UAV 12 is contained within the containment area 72 of the containment apparatus 10, it is important that the netting sections 52 have a diameter 54 that is small enough that the UAV 12 cannot pass though the respective netting sections 52, but a diameter 54 large enough that the propellers of the UAV 12 are caught in the netting upon contact therewith, thereby fixing the UAV 12 to the panel 36, rather than allowing the UAV 12 to simply bounce off the panel 36 and become destabilized in flight.

In one example embodiment, the netting comprises a UV-resistant nylon material, namely a nylon material that maintains an ability to resist UV radiation, such that the material does not degrade over time or degrades at a more gradual rate when placed in direct contact with UV radiation or sunlight. For example, the netting can be a size #9 trammel walling Nylon net with UV resistance. In this example, the netting has a 10 mesh weight of 32 yards/lb. Further, in this example the diameter 54 of the netting section 52 is about fourteen inches. The netting can alternatively be a #21 knotted Nylon Seine net with UV resistance. In this example, the netting has a 42 mesh weight of nine square foot per pound (lb.). Further, in this example, the diameter 54 of the netting section 52 is about five inches.

Referring to FIG. 2, the attachment border 44 and the opposing side portions 48 are woven through the mesh material of the panel interior 42. Further, the rigid coil border 46 is woven through the mesh material of the panel interior 42 or otherwise fixed to the panel interior 42.

In one example, the plurality of panels 36 includes a first panel 36a and a second panel 36b, one of the opposing sides 48 of the first panel 36a and one of the opposing sides 48 of the second panel 36b are operatively coupled at a plurality of predefined panel attachment points 68. The respective opposing sides 48 of the first panel 36a and the second panel 36b can be coupled via a fastener, for example, a wire tie, hose tie, steggel tie, zap strap, or zip tie. Alternatively, the first panel 36a and the second panel 36b can be coupled via a twine, such as a seine twine. In one example, the twine is a #18 twine, which may be tarred. The twine can be made of a polymeric material, such as Nylon or polypropylene or an organic material such as cotton, jute, sisal, or hemp. In one particular, non-limiting example, the twine is a #18 tarred Nylon Seine Twine.

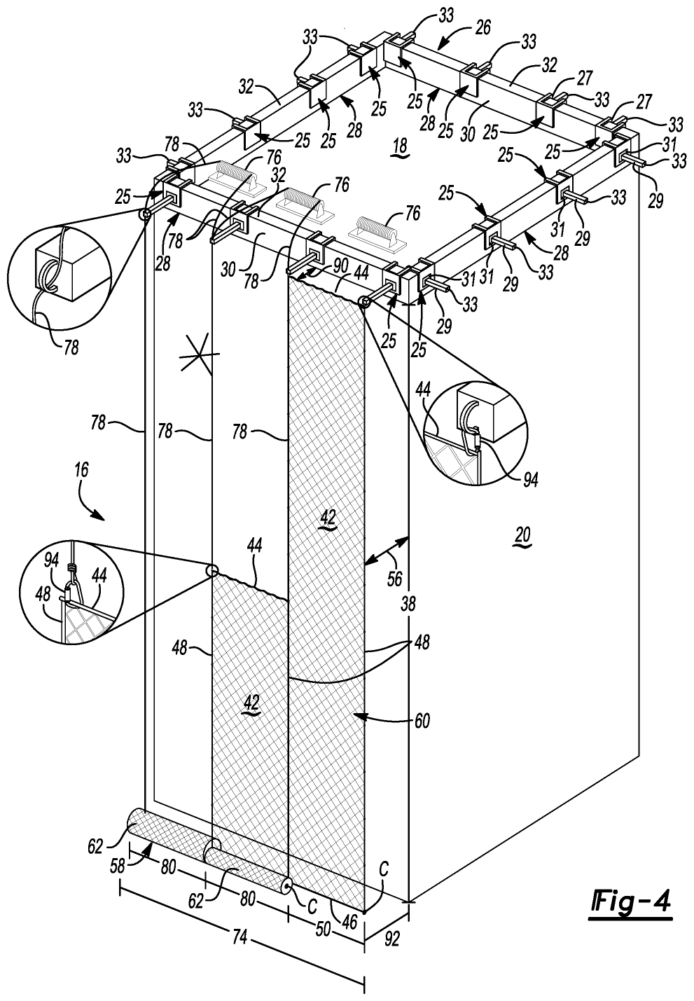

Referring to FIGS. 2 and 4, the panel 36 can occupy one of a coiled position 58 and an installed position 60. In the coiled position 58, the respective panel 36 is disposed about the rigid member defined as the coil border 46. In the coiled position 58 the panel 36 forms a transportable panel coil 62. The transportable panel coil 62 is a rolled form of the panel 36, wherein the panel 36 is rotationally disposed about the coil border 46 to form the transportable panel coil 62, such that the coil border 46 is disposed at an interior rotational center C of the transportable panel coil 62. When the panel 36 is embodied as a transportable panel coil 62 in the coiled position 58, such a configuration provides for ease of movement and transport. The transportable panel coils 62 may be positioned in a predefined position proximate to one of the exterior walls 20 of the structure 16 and opposite the roof 18. In one example, the transportable panel coils 62 are disposed laterally from the respective exterior wall 20 of the structure 16 a coil distance 92.

In the installed position 60, at least one of the panel perimeter portions 44, 48 of a respective panel 36 is operatively attached to the roof 18 of the pre-existing structure 16. More particularly, the attachment border 44 is operatively attached to the pre-existing structure 16 at the second end 33 of the parapet attachment 25 extension member 27. In such an example, the panel 36 is laterally spaced apart from the respective exterior wall 20 of the structure 16 by at least the attachment distance 90 and extends along the height 38 between the coil border 46 and the attachment border 44 and forms a removable barrier to at least one of the exterior walls 20 of the structure 16.

As shown in FIG. 1, when the plurality of panels 36 are in the installed position 60, the plurality of panels 36 and at least one of the exterior walls 20 of the structure 16 cooperate to define a periphery of a UAV containment area 72. The UAV containment area 72 defines a controlled environment, directly adjacent to the structure 16, within which an unmanned aerial vehicle (UAV) 12 can be operated in a controlled manner, for example, to complete an inspection of the pre-existing structure 16.

In an example embodiment, the periphery of the UAV containment area 72 is defined by the height 38, the attachment distance 90, the coil distance 92, a predefined distance 56, and a collective panel width 74, wherein the collective panel width 74 is defined as the sum of the panel widths 50 of each of the respective panels of the plurality of panels 36.

In one example, the coil distance 92 may be greater than the attachment distance 90, such that the panel 36 is laterally spaced apart from the pre-existing structure 16 by a predefined distance 56, which is between the attachment distance 90 and the coil distance 92. In another example, each of the attachment distance 90, the coil distance 92, and the predefined distance 56 are equal. As such, in any example, the containment area 72 may be rectangular or non-rectangular, e.g., trapezoidal or triangular.

In one example embodiment, the panel width 50 is from about four feet to about twenty feet. In one example, the panel width 50 may be from about four feet to about twelve feet. In another example, the panel width 50 may be from about eight feet to about sixteen feet. In another example, the panel width 50 may be from about ten feet to about eighteen feet. In another example, the panel width 50 may be of from about twelve feet to about twenty feet.

In one example embodiment, the height 38 of the panel 36 in the installed position 60 is approximately equal to the predefined height of the structure 16.

In one example embodiment, the predefined distance 56 can vary along the height 38 from about one foot to about twelve feet. As previously described, the predefined distance 56 can vary along the height 38 of the panels 36 from a coil distance 92 at the coil border 46 to an attachment distance 90 at the attachment border 44. In one example, the predefined distance 56 may be from about two feet to about eight feet. In another example, the predefined distance 56 may be from about four feet to about eight feet. In another example, the predefined distance 56 may be from about six feet to about ten feet. In another example, the predefined distance 56 may be from about eight feet to about twelve feet.

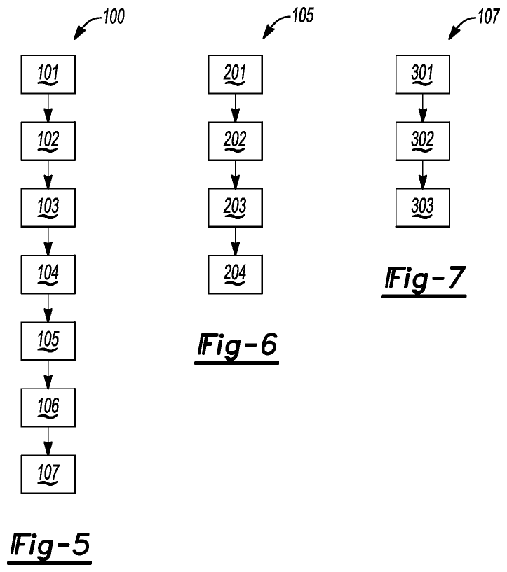

Referring to FIGS. 5 and 6, and with reference to FIGS. 2 and 4, a method of installation 100 for an unmanned aerial vehicle (UAV) 12 containment apparatus 10 on a pre-existing structure 16 having a roof 18 and a plurality of exterior side walls 20 is provided. The method comprises steps 101 through 107 as detailed in FIG. 5.

At step 101 a winch hoist 76, a parapet attachment 25, one or more winching members 78, and a plurality of transportable panel coils 62 are provided. The winch hoist 76 can be a manually-operated, electronically controlled, or pneumatically controlled winch hoist 76 capable of lifting and lowering at least one of the respective panels 36. In its simplest form, the winch hoist 76 consists of a spool or winch drum and attached hand crank. More elaborate designs have gear assemblies and can be powered by electric, hydraulic, pneumatic or internal combustion drives. Some winch hoists 76 can include a solenoid brake and/or a mechanical brake or ratchet and pawl device that prevents the winch hoist 76 from unwinding unless the pawl is retracted.

More particularly, the winch hoist 76 can be used to pull in (wind up) or let out (wind out) or otherwise adjust the tension of the winching members 78 in order to lift and lower the respective panels 36 between the coiled position 58 and the installed position 60. The winch hoist 76 can be disposed upon and operatively secured to the roof 18 of the pre-existing structure 16 as shown in FIGS. 1 and 4.

As shown in FIGS. 2 and 3, the parapet attachment 25 can have a support structure 27 attachable to the parapet 26. In a non-limiting example, the support structure 27 is disposed over the top side 32 of the parapet 26 and clamps to the two vertical sides 30 of the parapet 26. The parapet attachment 25 can further include an extension member 29 having a first end 31 proximate the support structure 27 and a second end 33 spaced apart from the support structure 27. The extension member 29 extends outwardly from the roof boundary 24 the attachment distance 90, such that the predefined distance 56 is at least the attachment distance 90 at the attachment border 44 of the panel 36.

Each of the winching members 78 is secured to the winch hoist 76 and to at least one of the parapet attachments 25. The winching members 78 are extended downward from the roof 18 of the pre-existing structure 16 along at least one of the exterior walls 20.

As shown in FIGS. 1 and 4, each transportable panel coil 62 comprises a panel 36 occupying a coiled position 58. Each of the panels 36 includes a panel perimeter 40 and a panel interior 42. The panel perimeter 40 can have a plurality of perimeter portions 44, 46, 48. The panel perimeter portions 44, 46, 48 of each panel 36 include an attachment border 44, a coil border 46, and a set of opposing side portions 48. The set of opposing side portions 48 define a panel width 50 therebetween. The panel width 50 is equivalent to the coil width 80 of the transportable panel coils 62.

When the panel 36 occupies the coiled position 58, the coil border 46 is formed as a rigid member disposed at an interior rotational center C of one of the respective transportable panel coil 62, such that the respective panel 36 is rotationally wound around the coil border 46 to form the transportable panel coil 62.

The attachment border 44 is configured for attachment to the roof 18 of the pre-existing structure 16. More particularly, when the panel 36 occupies the installed position 60, the attachment border 44 is operatively connected to the second end 33 of the extension member 29 of the parapet attachment 25 and the coil border 46 is disposed opposite the attachment border 44 such that the panel height 38 is defined between the attachment border 44 and coil border 46.

At step 102, shown in FIG. 5, the transportable panel coils 62 are positioned in a predefined position proximate to one of the exterior walls 20 of the structure 16 and opposite the roof 18. In one example, the transportable panel coils 62 are disposed laterally from the respective exterior wall 20 of the structure 16 the coil distance 92. In one example, the coil distance 92 is equal or greater than the attachment distance 90, such that in the installed position, the panels 36 are laterally spaced apart from the respective exterior wall 20 a predefined distance 56, which is between the attachment distance 90 and the coil distance 92.

At step 103, the winching members 78 are extended from the winch hoist 76, connected to the parapet attachment 25, and further extended downward from the roof 18 and the parapet 26 and along the respective exterior wall 20 to the transportable panel coil 62, e.g. the winching members 78 are let out via the winch hoist 76 until they reach the transportable panel coil 62.

At step 104, the winching members 78 are operatively attached to the attachment border 44 of the respective panel 36. The winching members 78 can be operatively attached to the attachment border 44 via a fastener 94 or the like.

At step 105, the panel 36 is transferred from the coiled position 58 to the installed position 60. In the coiled position 58, the panel 36 is embodied as one of the transportable panel coils 62. In the installed position 60, the attachment border 44 of the panel 36 is secured to the roof 18 at the second end 33 of the parapet extension member 29, such that the panel 36 is extended along the height 38 between the attachment border 44 and the coil border 46 and forms a removable barrier to the respective exterior wall 20, defining a containment area 72 therebetween.

Step 105, is further defined in FIG. 6 and includes the additional steps shown as steps 201 through 204 therein. At step 201, the winch hoist 76 is powered to retract, e.g., pull in (wind up) the winching members 78. As the winching members 78 are retracted by the winch hoist 76 the attachment border 44 of the panel 36, which is operatively attached to the winching members 78, is lifted along the respective exterior wall 20 toward the roof 18 of the structure 16. As the attachment border 44 is lifted along the respective exterior wall 20, the transportable panel coil 62 rotates about the coil border 46 or unwinds, as the panel 36 is transferred from a coiled position 58 to the installed position 60, wherein the panel is extended along the height 38 between the attachment border 44 and the coil border 46 and forms a removable barrier to the respective exterior wall 20.

Once the attachment border 44 reaches the roof 18, at step 202, the attachment border 44 is secured to the second end 33 of the extension member 27 of the parapet attachment 25. The attachment border 44 can be operatively attached to the second end 33 of the extension member 27 via a clamp, fastener 94, or other attachment apparatus.

At step 203, the winching members 78 can be detached from the attachment border 44 of the respective panel 36.

In an example wherein, the plurality of panels 36 includes a first panel 36a and a second panel 36b, the method 100 can further include operatively coupling the first panel 36a and the second panel 36b at a plurality of predefined panel attachment points 68, as shown at step 204. The respective opposing sides 48 of the first panel 36a and the second panel 36b can be coupled via a fastener, for example, a wire tie, hose tie, steggel tie, zap strap, or zip tie. Alternatively, the first panel 36a and the second panel 36b can be coupled via a rope or twine as previously described herein.

Once fully secured in the installed position 60, the respective panel 36 extends along the height 38 and is disposed laterally from the respective exterior wall 20 of the structure 16 by the predefined distance 56, so as to form a removable barrier to at least one of the exterior walls 20 of the structure 16. The predefined distance 56, can vary along the height 38 of the panel 38 between the attachment distance 90 at the attachment border 44 and the coil distance 92 at the coil border 46. However, in any example, the predefined distance 56 is at least the attachment distance 90.

In one example, the attachment distance 90 may be zero and, in turn, the predefined distance 56 at the attachment border 44 is also zero. In such an example, the attachment distance 90 may be zero, i.e., the attachment border 44 can be attached directly to the vertical sidewall of 30 of the parapet 26, wherein no parapet attachment 25 is present. In this example, the coil distance 92 is be greater than the attachment distance 90, such that the panel 36 is laterally spaced apart from the pre-existing structure 16 by a predefined distance 56, which is between the attachment distance 90 and the coil distance 92. In this example, the containment area 72 is trapezoidal or triangular; however, the predefined distance 56, in this instance, the predefined distance 56 is maintained from about four to about eight feet in the area to be inspected to allow for the maneuvering the UAV 12.

In another example, the panel 36 may be laterally spaced apart from the respective exterior wall 20 of the structure 16 by the attachment distance 90, which is equal to a length of the extension member 29, wherein the attachment border 44 is attached to second end 33 of the extension member 29. In such an example, the extension member 29 extends outwardly from the roof boundary 24 by the attachment distance 90, such that the predefined distance 56 is at least the attachment distance 90. In this example, the predefined distance 56 may be from about one foot to about twelve feet. In this example, each of the attachment distance 90, the coil distance 92, and the predefined distance 56 may be equal or the coil distance 92 may be greater than the attachment distance 90. As such, in such an example, the containment area 72 may be rectangular or non-rectangular, e.g., trapezoidal or triangular.

Accordingly, in the installed position 60, the plurality of panels 36 and at least one of the exterior walls 20 of the structure 16 cooperate to define a periphery of a UAV containment area 72 defined by the height 38, the predefined distance 56, and a collective panel width 74, wherein the collective panel width 74 is defined as the sum of the panel width 50 of each of the respective panels of the plurality of panels 36. As such, the UAV containment area 72 defines a controlled environment, directly adjacent to the structure 16, within which an unmanned aerial vehicle (UAV) 12 can be operated in a controlled manner, for example, to complete an inspection of the pre-existing structure 16 and identify damaged areas 22 thereof.

Referring back to FIG. 5, the method further includes step 106, namely, operating a UAV 12, in a controlled manner, within the UAV containment area 72, such that the UAV may, for example, perform an inspection of the structure 16 and collect data regarding the condition of the roof 18 and exterior walls 20 of the structure 16 disposed within the UAV containment area 72. Further, during the inspection, an operator 34 can initiate an automatic scanning process of the pre-existing structure 16 and the damaged areas 22 thereof and quickly and safely obtain detailed image, video, or other sensory data regarding the damaged area 22. The UAV 12 can then store, and/or transmit detailed image, video, or other sensory data, which can be transferred to another platform for inspection and analysis.

The method can further include step 107, namely, transferring the panel 36 from the installed position 60 to the coiled position 58. Step 107 can be completed at the end of the inspection when the UAV 12 is safely grounded.

Step 107, is further defined in FIG. 7 and includes the additional steps shown as steps 301 through 303 detailed therein.

At step 301, the winching members 78 are extended from the winch hoist 76, connected to the parapet attachment 25, and are operatively re-attached to the attachment border 44 of the respective panel 36. The winching members 78 can be operatively attached to the attachment border 44 via a fastener 94 or the like.

At step 302, the attachment border 44 is detached from the parapet attachment extension member 27.

At step 303, the winch hoist 76 is powered to let out, wind out, or otherwise extend the winching members 78 downward from the roof 18 and the parapet 26 and along the respective exterior wall 20. As the winching members 78 are let out or extended downward, the attachment border 44 is lowered along the respective exterior wall 20 of the structure 16. As the attachment border 44 is lowered the coil member 46 is rotated, such that the panel 36 is rotated and coiled about the coil member 46 to return to the coiled position 58, that is, to reform one of the transportable panel coils 62 for transport and job clean-up.

While the best modes for carrying out the disclosure have been described in detail, those familiar with the art to which this disclosure relates will recognize various alternative designs and embodiments for practicing the disclosure within the scope of the appended claims.

1. A containment apparatus for an unmanned aerial vehicle (UAV) configured for attachment to a structure having a roof and a plurality of exterior walls, the containment apparatus comprising:
a plurality of panels, wherein each panel comprises:
a panel perimeter having a plurality of panel perimeter portions;
a panel interior disposed within the panel perimeter between the panel perimeter portions;
wherein, each panel occupies one of a coiled position and an installed position, such that in the installed position, at least one of the panel perimeter portions of at least one panel is operatively attached to the structure at the one of the roof and one of the exterior walls, such that the at least one panel extends along a height and forms a removable barrier to at least one of the exterior walls of the structure; and
wherein when the at least one panel occupies the installed position, the at least one panel and at least one of the exterior walls of the structure cooperate to define a periphery of a UAV containment area.

2. The containment apparatus of claim 1 wherein the panel perimeter portions include an attachment border, a coil border, and a set of opposing side portions, and wherein when the at least one panel occupies the installed position:
the attachment border is operatively attached to the roof of the structure, via a parapet attachment having an extension member which extends outwardly an attachment distance from the roof, such that the panel is disposed laterally from the respective exterior wall of the structure a predefined distance;
wherein the coil border is disposed opposite the attachment border, such that the attachment border and the coil border define the height of the respective panel; and
wherein the set of opposing side portions define a respective panel width therebetween.

3. The containment apparatus of claim 2 wherein the coil border is disposed laterally from the respective exterior wall of the structure a coil distance.

4. The containment apparatus of claim 3 wherein the predefined distance is disposed between the coil distance and the attachment distance along the height, and wherein the predefined distance is from about four feet to about ten feet.

5. The containment apparatus of claim 4 wherein the coil distance is greater than the attachment distance.

6. The containment apparatus of claim 4 wherein the periphery of the UAV containment area is defined by the height, the predefined distance, and a collective panel width, wherein the collective panel width is defined as the sum of the panel widths of each of the respective panels of the plurality of panels; and
wherein the periphery of the UAV containment area defines a controlled inspection space, directly adjacent to the structure, for unmanned aerial vehicle (UAV) operation.

7. The containment apparatus of claim 6 wherein the plurality of panels includes a first panel and a second panel, wherein one of the opposing sides of the first panel and one of the opposing sides of the second panel are operatively coupled at a plurality of predefined panel attachment points.

8. The containment apparatus of claim 7 wherein the respective panel width is from about 12 feet to about 15 feet and the predefined distance is about 8 feet.

9. The containment apparatus of claim 2 wherein the respective panel occupies the coiled position, and wherein:
the coil border comprises a rigid member; and
the panel is rotationally disposed about the coil border to form a transportable panel coil, such that the coil border is disposed at an interior rotational center of the transportable panel coil.

10. The containment apparatus of claim 9 wherein the attachment border and the opposing side portions comprise a polypropylene rope.

11. The containment apparatus of claim 10 wherein the panel interior comprises a mesh material, and wherein the attachment border and the opposing side portions are woven through the mesh material.

12. The containment apparatus of claim 11 wherein the mesh material comprises a netting having a plurality of netting sections.

13. The containment apparatus of claim 12 wherein the netting sections have a diameter from about 4 inches to about 14 inches.

14. The containment apparatus of claim 13 wherein the netting comprises a UVA-resistant nylon material.

15. A method of installation for an unmanned aerial vehicle (UAV) containment apparatus on a pre-existing structure having a roof and a plurality of exterior side walls, the method comprising the steps of:
providing a winch hoist, a plurality of winching members, and a plurality of transportable panel coils, wherein:
the winch hoist is disposed upon and secured to the roof of the pre-existing structure;
the plurality of winching members is secured to the winch hoist and a parapet attachment having an extension member which extends outwardly a predefined distance from the roof;
each transportable panel coil comprises a panel occupying a coiled position, the respective panel having a panel perimeter and a panel interior, wherein:
the panel perimeter includes an attachment border configured for attachment to the roof of the pre-existing structure, a coil border formed as a rigid member disposed at an interior rotational center of one of the respective transportable panel coils, such that the panel is disposed rotationally about the coil border, and a set of opposing side portions, such that the set of opposing side portions define a panel width therebetween and the panel width is equal to a coil width;
the panel interior is disposed within the panel perimeter between the attachment border, the coil border, and the set of opposing side portions;
positioning the transportable panel coils in a predefined position near one of the exterior walls of the structure and opposite the roof, wherein the predefined position is disposed laterally from the respective exterior wall of the structure a coil distance;
extending the winching members downward from the roof along the respective exterior wall until the winching members reach the respective transportable panel coil;
attaching the winching members to the attachment border of the respective panel; and
transferring the panel from a coiled position to an installed position, wherein in the coiled position the panel is embodied as one of the transportable panel coils, and wherein in the installed position the attachment border of the panel is secured to the parapet attachment extension member which extends outwardly an attachment distance from the roof, such that the panel is extended along a height between the attachment border and the coil border and forms a removable barrier to the respective exterior wall.

16. The method of claim 15 wherein transferring the panel from a coiled position to an installed position further includes the steps of:
powering the winch hoist to retract the winching members, wherein the attachment border of the panel is lifted along the respective exterior wall toward the roof of the structure, such that the transportable panel coil rotates about the coil border as the panel is transferred from a coiled position to an installed position;
securing the attachment border to the roof at the parapet attachment extension member, such that the respective panel is disposed laterally from the respective exterior wall of the structure the predefined distance, wherein the plurality of panels and at least one of the exterior walls of the structure cooperate to define a periphery of a UAV containment area defined by the height, the predefined distance, and a collective panel width, wherein the collective panel width is defined as the sum of the panel widths of each of the respective panels of the plurality of panels; and
detaching the winching members from the attachment border of the respective panel.

17. The method of claim 16 further comprising operating a UAV within the periphery of the UAV containment area, such that the UAV performs an inspection of the structure and collects data regarding a condition of the roof and exterior walls of the structure disposed within the UAV containment area.

18. The method of claim 17 wherein the method further includes the step of transferring the panel from the installed position to the coiled position, wherein transferring the panel from the installed position to the coiled position further includes:
attaching the winching members to the attachment border of the respective panel;
detaching the attachment border from the parapet attachment extension member; and
powering the winch hoist to extend the winching members and lowering the attachment border downward along the respective exterior wall of the structure and simultaneously rotating the coil member, such that the panel is rotatably disposed about the coil member as the panel is lowered along the respective exterior wall of the structure to reform one of the transportable panel coils.

19. The method of claim 18 wherein:
the attachment border and the opposing side portions comprise a polypropylene rope;
the coil border comprises a rigid member;
the panel interior comprises a mesh material, and wherein the attachment border and the opposing side portions are woven through the mesh material; and
wherein the mesh material comprises a netting having a plurality of netting sections and wherein the netting sections have a diameter from about 4 inches to about 14 inches.

20. The method of claim 19 wherein:
the predefined distance is disposed between the coil distance and the attachment distance along the height;
the predefined distance is from about four feet to about ten feet; and
the panel width and the coil width is from about 12 feet to about 15 feet.
